(19) United States
(12) Patent Application Publication
(10) Pub. No.: US 2011/0043562 A1
(43) Pub. Date: Feb. 24, 2011

(54) INKJET RECORDING APPARATUS

(75) Inventors: Atsushi Kubota, Shizuoka-ken (JP); Kazuhiko Ohtsu, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/854,933

(22) Filed: Aug. 12, 2010

Related U.S. Application Data
(60) Provisional application No. 61/236,244, filed on Aug. 24, 2009.

(51) Int. Cl. B41J 29/38

(52) U.S. Cl. 347/16

(57) ABSTRACT

According to one embodiment, an inkjet recording apparatus includes a sensor, a first controller and a second controller. The sensor is provided upstream of an inkjet head in a paper transport direction and detects a state of an image forming surface of a paper. The first controller determines whether the image forming surface subjected to the state detected by the sensor is printed with a coloring material other than inkjet inks. The second controller controls to discharge the paper without image formation on the image forming surface with the inkjet head if the image forming surface is printed with the coloring material other than the inkjet inks.

### CROSS-REFERENCE TO RELATED APPLICATIONS

This application is based upon and claims the benefit of priority from Provisional Application No. 61/236,244 filed on Aug. 24, 2009, the entire contents of which are incorporated herein by reference.

### FIELD

Embodiments described herein relate generally to an inkjet recording apparatus which detects a paper surface prior to imaging forming process.

### BACKGROUND

Desktop publishing that uses a computer to create publication documents is common in offices and other places. Desktop publishing requires the output of not only texts and graphics but the output of texts and graphics with color natural images such as pictures.

In inkjet recording apparatuses, ink droplets ejected through nozzles adhere to a paper surface. The adhered ink on the paper permeates the paper in the thickness direction as it diffuses out on the paper surface. The ink adhered on the paper then dries and fixes on the paper. Inkjet recording apparatuses produce images on paper using this mechanism involving the permeation, drying, and fixing of the ink.

For saving resources, a recording apparatus that produces prints using recycled paper is available. In such a recording apparatus, the erasable toner used for printing is erased from the printed portion, and the paper is used again for further printing. However, while the colors disappear from the surface of the paper, a transparent resin remains on the paper surface. Thus, if the toner-erased surface were used for image formation by an inkjet recording apparatus, the ink adhered to the paper does not dry because of the transparent resin, and causes image disturbance and a fixing problem. As a result, the quality of the image formed on the paper deteriorates.

### BRIEF DESCRIPTION OF THE DRAWINGS

FIG. 1 is an exemplary longitudinal section of an inkjet recording apparatus according to an embodiment;

FIG. 2 is an exemplary diagram representing a configuration of a paper sensor unit according to the embodiment;

FIG. 3 is an exemplary block diagram illustrating a control system of the inkjet recording apparatus according to the embodiment; and

FIG. 4 is an exemplary flowchart representing an imaging forming process according to the embodiment.

### DETAILED DESCRIPTION

In general, according to one embodiment, an inkjet recording apparatus includes a sensor, a first controller and a second controller. The sensor is provided upstream of an inkjet head in a paper transport direction and detects a state of an image forming surface of a paper. The first controller determines whether the image forming surface subjected to the state detected by the sensor is printed with a coloring material other than inkjet inks. The second controller controls to discharge the paper without image formation on the image forming surface with the inkjet head if the image forming surface is printed with the coloring material other than the inkjet inks.

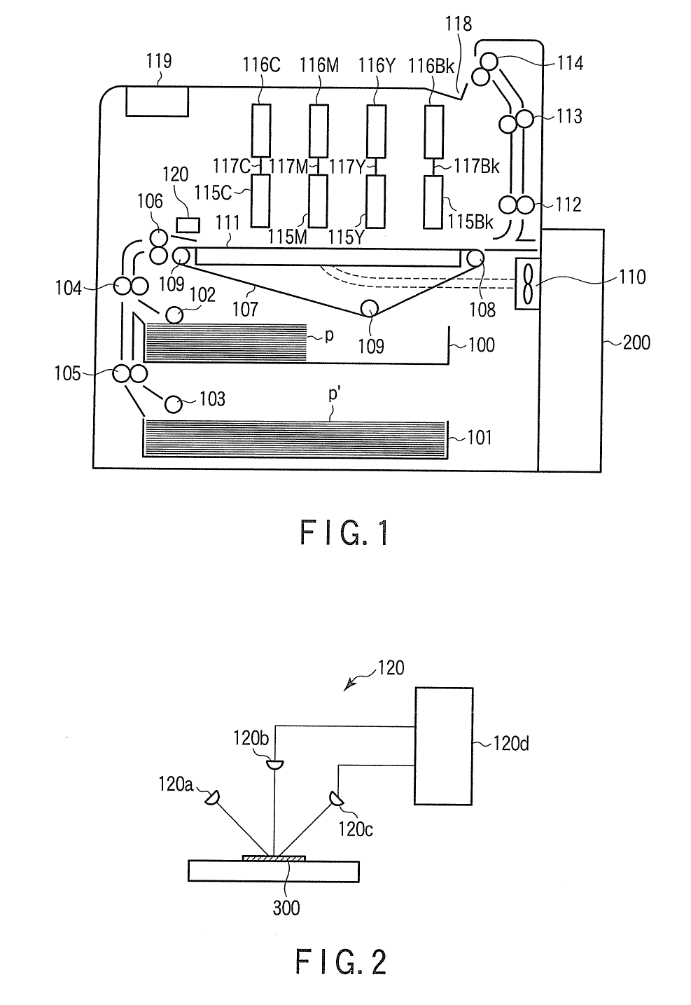

An embodiment is described below with reference to the accompanying drawings. FIG. 1 is a longitudinal section of an inkjet recording apparatus 1 according to an embodiment. A first paper cassette 100 stores a paper stack p of a plurality of papers (recording medium). A second paper cassette 101 stores a paper stack p′ of a plurality of papers of a size different from the size of the papers stored in the first paper cassette 100. A first paper feed roller 102 picks up papers of a selected paper size from the paper stack p stored in the first paper cassette 100, one at a time from the top. The first paper feed roller 102 then transports the paper to a first pair of transport rollers 104 and a paper feeding unit 106 that includes a pair of register rollers. In the same manner, a second paper feed roller 103 picks up papers of a select paper size from the paper stack p′ stored in the second paper cassette 101, one at a time, and transports it to a second pair of transport rollers 105, the first pair of transport rollers 104, and the paper feeding unit 106. The paper feeding unit 106 is realized by, for example, a pair of register rollers.

A conveyer belt 107 is suspended in an endless fashion by a drive roller 108 and two driven rollers 109. The conveyer belt 107 has the tension produced by the drive roller 108 and the two driven rollers 109. The conveyer belt 107 has holes formed through it at predetermined intervals. A vacuum chamber 111 connected to a fan 110 is installed on the inner side of the conveyer belt 107 so as to suck the paper onto the conveyer belt 107.

The drive roller 108 drives the conveyer belt 107 so that the paper is transported from the side upstream of the paper feeding unit 106 (the left-hand side in FIG. 1) to the side downstream of the paper discharge unit including a first pair of transport rollers 112, a second pair of transport rollers 113, and a third pair of transport rollers 114 (the right-hand side in FIG. 1).

Four columns of inkjet recording heads that eject inks on a paper according to print data are disposed above the conveyer belt 107. Specifically, an inkjet recording head 115C, an inkjet recording head 115M, an inkjet recording head 115Y, and an inkjet recording head 115Bk that eject a cyan (C) ink, a magenta (M) ink, a yellow (Y) ink, and a black (Bk) ink, respectively, are disposed in the inkjet recording apparatus 1, in this order from the upstream side. Here, the inkjet heads 115C, 115M, 115Y, and 115Bk are also referred to as image forming sections.

Each of the inkjet heads 115C, 115M, 115Y, and 115Bk has ink droplet-ejecting nozzles disposed at a predetermined resolution along the paper width direction. In other words, the inkjet recording heads 115C, 115M, 115Y, and 115Bk are line-type heads in which a plurality of nozzles (not illustrated) is arranged along lines. In the inkjet recording heads 115C, 115M, 115Y, and 115Bk, the nozzles are arranged in a direction orthogonal to the transport direction of the paper on the conveyer belt 107. The nozzles are arranged with a specified distance from the paper on the transport belt 107.

The inkjet recording heads 115C, 115M, 115Y, and 115Bk are connected to an ink cartridge 116C, an ink cartridge 116M, an ink cartridge 116Y, and an ink cartridge 116Bk, respectively, via a tube 117C, a tube 117M, a tube 117Y, and a tube 117Bk. The cyan (C) ink cartridge 116C, the magenta (M) ink cartridge 116M, the yellow (Y) ink cartridge 116Y, and the black (Bk) ink cartridge 116Bk store inks of the respective colors.

The distance between the paper surface and each of the ends of the inkjet recording heads 115C, 115M, 115Y, and 115Bk on the side of the transport belt 107 is maintained constant by the vacuum chamber 111. The inkjet recording heads 115C, 115M, 115Y, and 115Bk eject inks of the respective colors at the transport timing of the paper onto the conveyer belt 107 through the transport unit 106, and in synchronism with the paper transport operation of the conveyer belt 107. In this manner, the inkjet recording heads 115C, 115M, 115Y, and 115Bk form a color image at desired positions on the paper surface.

The first pair of transport rollers 112, the second pair of transport rollers 113, and the third pair of transport rollers 114 discharge the paper to a paper discharge tray 118 after a full-color image is formed on the paper surface by the inkjet recording heads 115C, 115M, 115Y, and 115Bk. The papers that did not undergo image formation are also discharged to the paper discharge tray 118 by these transport rollers, as will be described later. The papers are stacked one after another on the paper discharge tray 118. The papers that did not undergo image formation may be discharged from the conveyer belt 107 to a collection box 200 provided inside or external to the inkjet recording apparatus 1. In FIG. 1, the collection box 200 is externally provided for the inkjet recording apparatus 1.

A display unit 119 is provided on the upper part of the inkjet recording apparatus 1. The display unit 119 displays various messages concerning the state of the inkjet recording apparatus 1, and various messages for a user. For example, the display unit 119 displays information concerning whether a print job is in progress or in standby. The display unit 119 also functions as a controller panel for user input.

A paper sensor unit 120 is provided in the vicinity of the paper feeding unit 106. In FIG. 1, the paper sensor 120 is provided upstream of the ink recording head 115C, and downstream of the paper feeding unit 106. The paper sensor unit 120 detects the state of a paper surface.

FIG. 2 is a block diagram illustrating a configuration of the paper sensor unit 120. The paper sensor unit 120 detects whether a printed portion 300 on the surface of the paper being processed for image formation is subjected to printing with a coloring material other than inkjet inks. The coloring material other than inkjet inks is, for example, a toner used in electrophotography, or a resin applied to paper in thermal printers. Note that the coloring material may be invisible because of heat or other treatment. Here, as an example, the paper sensor unit 120 is adapted to determine whether the paper is subjected to printing with toners used in electrophotography.

The paper sensor unit 120 includes a light source 120a, a first photoreceiver 120b, a second photoreceiver 120c, and a determining unit 120d. The light source 120a shines measurement light on paper. The light source 120a is, for example, an LED. The first photoreceiver 120b receives the difusely reflected light off the printed portion 300 (hereinafter, “diffusely reflected light”). The first photoreceiver 120b is, for example, a photocoupler. The second photoreceiver 120c receives the specularly reflected light and difusely reflected light off the paper. The second photoreceiver 120c is, for example, a photocoupler. The determining unit 120d determines whether the paper is subjected to printing with a coloring material other than inkjet inks, based on the outputs of the first light receiving element 120b and the second light receiving element 120c. The determining unit 120d determines whether the paper is subjected to printing with a color toner, based on the output of the first light receiving element 120b. The determining unit 120d determines whether the paper is subjected to printing with a black toner, based on the output of the second light receiving element 120c. The determining unit 120d is, for example, a differential circuit.

In this way, the paper sensor unit 120 can detect whether an image is formed on the paper with different toners, particularly toners of different light reflection characteristics, such as a black toner and color toners. Here, the term “printed paper” is used to refer to papers being processed for image formation, and that have a printed image produced by a coloring material other than inkjet inks. The term “unprinted paper” is used to refer to papers being processed for image formation, and that do not have a printed image produced by a coloring material other than inkjet inks. The paper sensor unit 120 is not limited to the foregoing configuration, as long as it can detect whether the paper is subjected to printing with a coloring material other than inkjet inks.

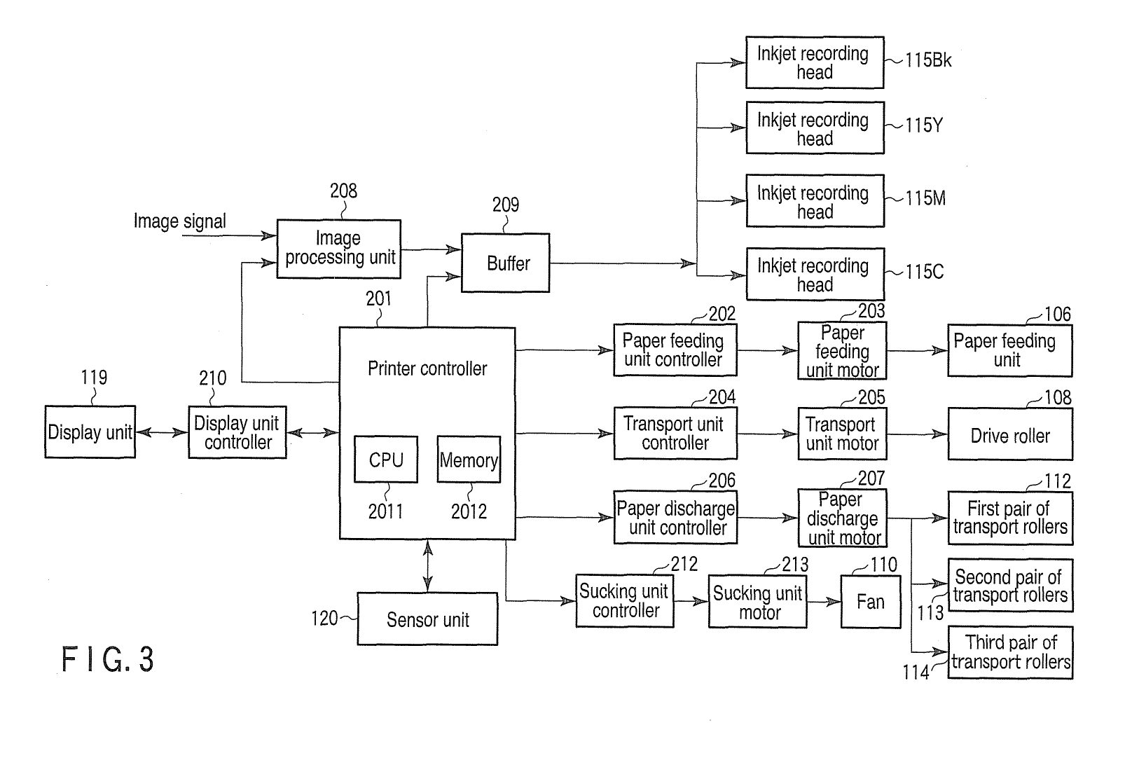

FIG. 3 is a block diagram representing a control system of the inkjet recording apparatus 1 according to the embodiment. The inkjet recording apparatus 1 includes a printer controller 201, a paper feeding unit controller 202, a paper feeding unit motor 203, a transport unit controller 204, a transport unit motor 205, a paper discharge unit controller 206, a paper discharge unit motor 207, an image processing unit 208, a buffer 209, a display unit controller 210, and a sucking unit controller 212.

The printer controller 201 is a microcomputer that includes a CPU 2011 and a memory 2012. The CPU 2011 executes various arithmetic processes according to the programs stored in the memory 2012. The CPU 2011 outputs control signals to each component. Further, the CPU 2011 controls the operation of each component based on the detection result for the paper surface detected by the paper sensor unit 120, as will be described later.

The paper feeding unit controller 202 controls the driving of the paper feeding unit motor 203. The paper feeding unit motor 203 drives the paper feeding unit 106. The paper feeding unit 106 feeds papers onto the conveyer belt 107. The transport unit controller 202 controls the driving of the transport unit motor 203. The transport unit motor 205 rotates the drive roller 108. The paper discharge unit controller 206 controls the driving of the paper discharge unit motor 207. The paper discharge unit motor 207 drives the first pair of transport rollers 112, the second pair of transport rollers 113, and the third pair of transport rollers 114.

The image processing unit 208 is realized by, for example, an integrated circuit. The image processing unit 208 subjects input image signals to image processing. The image processing unit 208 then converts the image signals to print data suited for printing by the inkjet recording heads 115C, 115M, 115Y, and 115Bk. The buffer 209 is an image memory. The buffer 209 temporarily stores the print data produced by the image processing unit 208. The buffer 209 outputs the print data to the inkjet heads 115C, 115M, 115Y, and 115Bk. The display unit controller 210 controls display information for the display unit 119 according to the control of the printer controller 201. The display unit controller 210 transfers input commands to the print controller 201 upon input of the commands by a user through the display unit 119 that serves as a touch panel. The sucking unit controller 212 controls the driving of the sucking unit motor 213.

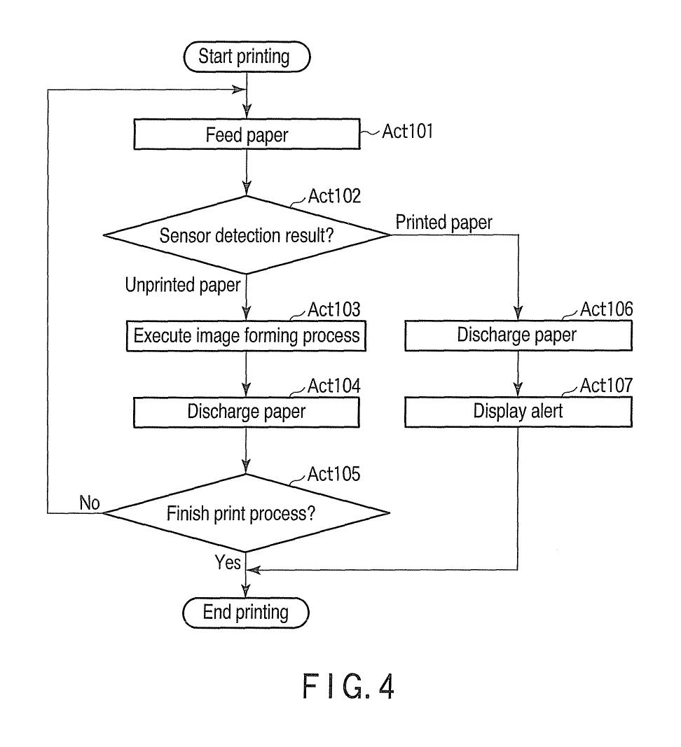

An image forming process of the inkjet recording apparatus 1 is described below. FIG. 4 is a flowchart representing the image forming process of the inkjet recording apparatus 1. In response to the inkjet recording apparatus 1 receiving print command signals from an external device along with image signals, the printer controller 201 controls the image processing unit 208 to convert the image signals to print data. The printer controller 201 controls to output the print data from the image processing unit 208 to the inkjet heads 116C, 116M, 116Y, and 116Bk. Further, the printer controller 201 controls the first paper feed roller 102 to pick up papers of a selected paper size from the paper stack p stored in the first paper cassette 100, one at a time from the top, and controls the first pair of transport rollers 104 to drive to transport the paper to the paper feeding unit 106 (Act 101). The paper feeding unit 106 feeds the paper onto the conveyer belt 107.

The printer controller 201 determines the state of the paper surface being processed for image formation, based on the detection result of the paper sensor unit 120. Specifically, the printer controller 201 determines whether the paper subjected to the detection by the sensor is an unprinted paper (Act 102). If the printer controller 201 determines that the paper subjected to the detection is an unprinted paper based on the detection result of the paper sensor unit 120 (Yes in Act 102), the printer controller 201 controls the inkjet recording heads 115C, 115M, 115Y, and 115Bk to form an image on the unprinted paper (Act 103). As used herein, the paper with an image formed by the inkjet recording heads 115C, 115M, 115Y, and 115Bk is referred to as an “image-formed paper”. The printer controller 201 controls the first pair of transport rollers 112, the second pair of transport rollers 113, and the third pair of transport rollers 114 to discharge the image-formed paper to the paper discharge tray 118 (Act 104).

The printer controller 201 determines whether to end the print process, based on print command signals from an external device (Act 105). If the printer controller 201 determines that the print process is finished (Yes in Act 105), the printer controller 201 ends the print process. If the printer controller 201 determines that the print process is not finished (No in Act 105), the printer controller 201 repeats the imaging forming process from Act 101.

If the printer controller 201 determines that the paper subjected to detection is not an unprinted paper (i.e., a printed paper) based on the detection result of the paper sensor unit 120 (No in Act 102), the print controller 201 controls the inkjet recording heads 115C, 115M, 115Y, and 115Bk not to form an image on the printed paper. Specifically, the print controller 201 controls the conveyer belt 107 so that the paper is simply passed the positions corresponding to the inkjet recording heads 115C, 115M, 115Y, and 115Bk. As used herein, the paper not subjected to image formation by the inkjet recording heads 115C, 115M, 115Y, and 115Bk is referred to as an “image-free paper.” The print controller 201 then controls the first pair of transport rollers 112, the second pair of transport rollers 113, and the third pair of transport rollers 114 to discharge the image-free paper to the paper discharge tray 118 (Act 106).

The print controller 201 controls the display unit 119 to display information that the paper is unprintable to form an image as instructed by the received print command signals (Act 107), and the controller 201 finishes the print process. Responding to the alert message displayed on the display unit 201, a user can check the sides of the papers in the paper stack p or p′ to enable proper printing upon resending of the print command signals.

Note that, in Act 106, the image-formed paper and the image-free paper do not necessarily discharge to the same paper discharge tray 118. For example, the paper discharge tray 118 may include two trays vertically disposed along the height of the inkjet recording apparatus 1. In this case, the upper tray and the lower tray may be adapted to receive the image-formed paper and the image-free paper, respectively.

The paper sensor unit 120 may be disposed at any position, as long as it is upstream of the ink recording head 115C with respect to the transport direction. The paper sensor unit 120 may be provided on the first paper cassette 100 and the second paper cassette 101, provided that the image forming side of the papers faces up in the first paper cassette 100 and the second paper cassette 101. In this case, the paper sensor 120 is provided on the first paper cassette 100 and the second paper cassette 101 so as to detect the upper side of the uppermost paper in the paper stack p or p′.

According to the embodiment, deterioration of image quality can be prevented that is caused when a paper printed with a coloring material other than inkjet inks, particularly with toners used in electrophotography, is subjected to image formation using inkjet inks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An inkjet recording apparatus comprising:
a sensor which is provided upstream of an inkjet head in a paper transport direction and detects a state of an image forming surface of a paper;
a first controller which determines whether the image forming surface detected by the sensor is printed with a coloring material other than inkjet inks; and
a second controller which controls to discharge the paper without image formation on the image forming surface with the inkjet head if the image forming surface is printed with the coloring material other than the inkjet inks.

2. The apparatus of claim 1, wherein the second controller controls to form an image on the image forming surface if the image forming surface is unprinted with the coloring material other than the inkjet inks.

3. The apparatus of claim 2, wherein the second controller controls to discharge the paper with the image and the paper without the image to different places.

4. The apparatus of claim 1, wherein the coloring material other than the inkjet inks is an electrophotographic toner.

5. The apparatus of claim 1, further comprising a display which displays information that the paper is unprintable to form an image.

6. An inkjet recording apparatus comprising:
a sensor which is provided upstream of an inkjet head in a paper transport direction, and detects a state of an image forming surface of a paper; and
a controller which discharges the paper without image formation on the image forming surface with the inkjet head if the sensor determines that the image forming surface is printed with a coloring material other than inkjet inks.

7. The apparatus of claim 6, wherein the controller controls to form an image on the image forming surface with the inkjet head if the image forming surface is unprinted with the coloring material other than the inkjet inks.

8. The apparatus of claim 7, wherein the controller controls to discharge the paper with the image and the paper without the image to different places.

9. The apparatus of claim 8, comprising
a first tray which is discharged the paper with the image, and
a second tray which is discharged the paper without the image.

10. The apparatus of claim 6, wherein the coloring material other than the inkjet inks is an electrophotographic toner.

11. The apparatus of claim 6, further comprising a display which displays information that the paper is unprintable to form an image.

12. The apparatus of claim 6, wherein the sensor is a light-reflecting type.

13. The apparatus of claim 6, wherein the sensor is a single sensor.

14. The apparatus of claim 13, wherein the sensor is disposed downstream of a cassette which is most downstream in the paper transport direction.

15. The apparatus of claim 6, wherein the inkjet head has a plurality of heads which eject different colors.

16. An inkjet recording method comprising:
detecting a state of an image forming surface of a paper with a sensor;
determining based on a result of detection by the sensor whether the image forming surface is printed with a coloring material other than inkjet inks; and
discharging the paper without image formation on the image forming surface if the paper is printed with the coloring material other than the inkjet inks.

17. The method of claim 16, wherein the coloring material other than the inkjet inks is an electrophotographic toner.
